(19) United States
(12) Patent Application Publication
(10) Pub. No.: US 2023/0391953 A1
(43) Pub. Date: Dec. 7, 2023

(54) POLYAMIDE COMPOSITIONS HAVING HIGH ADHESION TO METAL AND USE THEREOF

(71) Applicant: ARKEMA FRANCE, COLOMBES (FR)

(72) Inventors: Clémence PACE, Shimogyo-ku, Kyoto (JP); Vincent GUILLAUME, Changshu, Jiangsu (CN); Mathieu SABARD, Serquigny (FR)

(73) Assignee: ARKEMA FRANCE, COLOMBES (FR)

(21) Appl. No.: 18/227,532

(22) PCT Filed: Jan. 26, 2022
(86) PCT No.: PCT/FR2022/050143

§ 371 Date: Jul. 28, 2023

(30) Foreign Application Priority Data
Jan. 29, 2021 (FR) FR2100855

(51) Int. Cl. C08G 69/08; C08G 69/26; C08G 69/36; C08K 7/14; C08L 23/12; C08K 5/5313; B29C 45/14; C09D 177/02; C09D 177/06

(52) U.S. Cl. CPC C08G 69/08; C08G 69/26; C08G 69/36; C08K 7/14; C08L 23/12; C08K 5/5313; B29C 45/14; C09D 177/02; C09D 177/06; C08L 2203/20; B29C 2045/14868; B29K 2077/00

(57) ABSTRACT

A composition including from: a) 35% to 100% by weight of at least one semicrystalline aliphatic polyamide and/or one polyamide of formula MXDZ wherein MXD is meta-xylylenediamine and Z is a C6 to C12 aliphatic dicarboxylic acid, the semicrystalline aliphatic polyamide and/or the polyamide of formula MXDZ having a total acidity between from 70 to 180 μeq/g and a total basicity of less than 100 μeq/g; b) 0 to 25% by weight of polyolefins; c) 0 to 60% by weight, of glass fibers; d) 0 to 2% by weight of at least one additive; e) 0 to 30% by weight of at least one flame retardant; the sum a)+b)+c)+d)+e) being equal to 100%, the semicrystalline aliphatic polyamide and/or the polyamide of formula MXDZ having a melt flow index (MFI) between from 4 to 50 g/10 min.

### TECHNICAL FIELD

The present invention relates to compositions comprising at least one polyamide having a high fluidity and acidity and which have strong adhesion to metal, to the use thereof for the manufacture of an article, in particular for electronics, sports, automobiles or industry and notably by injection molding.

### PRIOR ART

Articles for electronics, sports, automotive or industrial applications must evolve toward being lighter in order to be of ever smaller size, and to be more discreet/easily transportable.

Thus in the context of electronics, notably in the context of cell phones and structural parts, it is necessary to manufacture light and strong products. The most widely used polymers are polyphenylene sulfide (PPS), polybutylene terephthalate (PBT), short-chain polyamide (PA), all these polymers being more often than not reinforced with glass fibers to increase their stiffness.

The implementation of the polymer on the metal parts can be carried out according to several methods and notably by nanomolding technology (NMT) which consists in overmolding a polymer on a metal support, the most widely used of which is aluminum.

For NMT, the adhesion between the polymer and the metal is strengthened owing to a specific physical pretreatment of the metal which results for example in the creation of nanoholes on the metal surface. The pretreatment may comprise several steps and may vary slightly depending on the polymer and the laboratory where it is carried out.

Thus, patent application EP2572876 describes a short-chain polyamide composition, comprising PA-66/6T/6I (in the weight ratio 12/62/26) and 30 wt % of glass fibers and which is applied to various metal surfaces.

According to application US 2018/0354168, the composition from EP2572876 does not have sufficient adhesion to metal and said application US 2018/0354168 then describes compositions comprising a mixture of a semicrystalline semiaromatic polyamide (sc-PPA) and an amorphous semiaromatic polyamide (am-PPA) for adhesion to metal.

However, neither of these two applications refers to the fluidity and acidity of the polyamides used. Moreover, the latter composition has high cycle times due to the higher injection-molding temperatures with the use of PPA.

International application WO18228999 describes a composition comprising a polyamide or a PPS or a polyester or else a mixture thereof and borosilicate glass fibers comprising mainly silica dioxide and boron trioxide for adhesion to metal. The brittleness compared to that of a composition with E glass fibers is reduced while improving adhesion according to the applicant.

No reference is made to the fluidity and acidity of the polyamides used. Furthermore, the adhesion values of the latter composition are not quantified but are expressed as relative values.

CN105694447 describes a PA resin composition used for NMT having an LDS function and includes PA66 and/or PA6 resin (30 to 90 parts), glass fibers (10 to 40 parts), inorganic yarns (3 to 25 parts), an LDS auxiliary agent (3 to 10 parts), a hardening agent (3 to 15 parts) and a lubricant (0.3 to 5 parts).

No reference is made to the fluidity and acidity of the polyamides used. Furthermore, the latter composition has adhesion values which are high.

One problem with plastic-metal hybrid parts in which the plastic material is a composition for example of fiber-reinforced polymer type is generally that the bond strength is still too low or that the material is too brittle or both.

Consequently, there is a need for compositions that make it possible to obtain plastic-metal hybrid parts, and for a process for preparing such parts, in which the above problems are reduced, i.e. that have a higher bond strength (or adhesion) and/or a lower brittleness.

This objective has been achieved by the compositions of the invention and also the process according to the invention using said composition and with the plastic-metal hybrid parts according to the invention and that can be obtained by such a process.

The present invention therefore relates to the use of a composition comprising:
a) 35% to 100% by weight, notably 35% to 75%, in particular 35% to 65% by weight of at least one semicrystalline aliphatic polyamide and/or one polyamide of formula MXDZ wherein MXD is meta-xylylenediamine and Z is a C6 to C12 aliphatic dicarboxylic acid, said semicrystalline aliphatic polyamide and/or said polyamide of formula MXDZ having a total acidity between from 70 to 180 μeq/g and a total basicity of less than 100 μeq/g, in particular less than 35 μeq/g;
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%,
said semicrystalline aliphatic polyamide and/or said polyamide of formula MXDZ having a melt flow index (MFI) between from 4 to 50 g/10 min, as measured according to standard ISO 1133:2011 under a load of 2.16 kg at 210° C.,
to increase the adhesion of said composition to a metal part after the deposition thereof by injection molding on said metal part, relative to the adhesion obtained after injection molding on said part with a composition comprising a semicrystalline aliphatic polyamide and/or a polyamide of MXDZ formula having at least one of the three properties, chosen from the MFI, total acidity and total basicity, which is different.

The inventors have therefore surprisingly found that the selection of a particular range of fluidity, represented here by the MFI, and of a particular range of total acidity and basicity of polyamides as defined above present in a composition, made it possible to increase the adhesion of said composition to a metal part after the deposition thereof by injection molding on said metal part relative to the adhesion obtained after injection molding on said part with a composition comprising a semicrystalline aliphatic polyamide and/or a polyamide of formula MXDZ having at least one of the three properties, chosen from the MFI, total acidity and total basicity, which is different, in other words having a different MFI, i.e. that is outside the particular range, and/or a different total acidity, i.e. that is outside the particular acidity range, and/or a different total basicity, i.e. that is outside the particular basicity range.

The adhesion of said composition to said metal part can be measured according to ISO 19095-2015.

Another advantage of the compositions of the invention consists of the possibility of recycling said compositions with the use in particular of a recyclable semicrystalline polyamide such as PA11 which is fluid and stable.

Assay of Total Acidity:

The acidity is measured according to the following method. 1 g of polyamide is dissolved in 80 ml of benzyl alcohol at high temperature. The sample is then cooled. Next, it is assayed by potentiometry using a Metrohm titrator (888 or 716) with a combined pH electrode, with a 0.02 N tetrabutylammonium hydroxide solution. The graph of potential as a function of volume gives a jump with an equivalent volume from which the acid chain ends are calculated by means of the following formula:

$$Acid chain ends ( meq / g ) = \frac{Veq \times [ TBAOH ]}{m} \qquad [ Math 1 ]$$

wherein
Veq denotes the equivalent volume obtained by means of the potentiometric assay,
[TBAOH] denotes the concentration of tetrabutylammonium hydroxide solution, i.e. 0.02 N,
m denotes the mass of the sample, i.e. 1 g.

Assay of Total Basicity:

The basicity is measured according to the following method. 1 g of polyamide is dissolved in 80 ml of metacresol at high temperature. The sample is then cooled. Next, it is assayed by potentiometry using a Metrohm titrator (888 or 716) with a combined pH electrode, with a 0.02 N solution of perchloric acid in acetic acid. The graph of potential as a function of volume gives a jump with an equivalent volume from which the amine chain ends are calculated by means of the following formula:

Amine chain ends (meq/g)=(Veq×[HClO4])/m [Math 2]

wherein
Veq denotes the equivalent volume obtained by means of the potentiometric assay,
[HClO4] denotes the concentration of perchloric acid solution, i.e. 0.02 N,
m denotes the mass of the sample, i.e. 1 g. Preferably, said polyamide has a total acidity between from 70 to 180 μeq/g and a total basicity of less than or equal to 30 μeq/g, and more particularly between 5 and 25 μeq/g.

Preferably, said at least one polyamide has a total acidity between from 80 to 130 μeq/g and a total basicity of less than 100 μeq/g, in particular less than 35 μeq/g.

Preferably, said polyamide has a total acidity between from 80 to 130 μeq/g and a total basicity of less than or equal to 30 μeq/g, and more particularly between 5 and 25 μeq/g.

Advantageously, the MFI of said semicrystalline aliphatic polyamide and/or a polyamide of formula MXDZ is between from 10 to 40 g/10 min under a load of 2.16 kg at 210° C.

Regarding the Metal Part (or Metal Substrate):

Said metal part can be any metal substrate which can be modified by a chemical and/or physical pretreatment and overmolded by a plastic by injection molding.

In one embodiment, said metal part is chosen from magnesium, aluminum, alloys thereof, alloys of stainless steel and other iron-based alloys.

Advantageously, said metal part is chemically or physically pretreated before injection molding of said composition.

The pretreatment applied to prepare the metal substrate used in the invention can be any process suitable for preparing a surface with surface irregularities of nanoscale dimensions.

In a suitable manner, such a pretreatment comprises multiple pretreatment steps.

Regarding the Composition Used:

It comprises:
a) 35% to 100% by weight, notably 35% to 75%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In one embodiment, the adhesion of said composition to said metal part is greater than 10 MPa, in particular greater than 15 MPa, notably greater than 20 MPa as measured according to standard ISO 19095-2015.

Advantageously, the adhesion of said composition to said metal part is greater than 15 MPa, notably greater than 20 MPa as measured according to standard ISO 19095-2015.

More advantageously, the adhesion of said composition to said metal part is greater than 20 MPa as measured according to standard ISO 19095-2015.

Advantageously, said composition is devoid of a laser direct structuring auxiliary agent. In a first embodiment, said composition comprises:
a) 35% to 90%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a second embodiment, said composition comprises:
a) notably 35% to 75%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment, said composition comprises:
a) 35% to 90%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment, said composition comprises:
a) 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) from 10% to 25% by weight of polyolefins;
c) from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment, said composition comprises:
a) 35% to 80%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment, said composition comprises:
a) 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment, said composition comprises:
a) 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) from 10% to 25% by weight of polyolefins;
c) from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a first variant, said composition comprises:
a) 35% to 100% by weight, notably 35% to 75%, in particular 35% to 65% by weight of at least one semicrystalline aliphatic polyamide,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the first variant, said composition of the first variant comprises:
a) 35% to 90% by weight, in particular 35% to 65%, in particular 35% to 55% by weight of at least one semicrystalline aliphatic polyamide,
b) from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a second embodiment of the first variant, said composition of the first variant comprises:
a) notably 35% to 75% by weight, in particular 35% to 65%, in particular 35% to 55% by weight of at least one semicrystalline aliphatic polyamide,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment of the first variant, said composition of the first variant comprises:
a) 35% to 90% by weight, in particular 35% to 65%, in particular 35% to 55% by weight of at least one semicrystalline aliphatic polyamide,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the first variant, said composition of the first variant comprises:
a) 35% to 65%, in particular 35% to 55% by weight of at least one semicrystalline aliphatic polyamide,
b) from 10% to 25% by weight of polyolefins;
c) from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the first variant, said composition of the first variant comprises:
a) 35% to 80%, in particular 35% to 55% by weight of at least one semicrystalline aliphatic polyamide,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the first variant, said composition of the first variant comprises:
a) 35% to 65%, in particular 35% to 55% by weight of at least one semicrystalline aliphatic polyamide,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the first variant, said composition of the first variant comprises:
a) 35% to 55% by weight of at least one semicrystalline aliphatic polyamide,
b) 10% to 25% by weight of polyolefins;
c) from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a second variant, said composition comprises:
a) 35% to 100% by weight, notably 35% to 75%, in particular 35% to 65% by weight of at least one polyamide of formula MXDZ wherein MXD is meta-xylylenediamine and Z is a C6 to C12 aliphatic dicarboxylic acid;
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the second variant, said composition of the second variant comprises:
a) 35% to 90%, in particular 35% to 65%, in particular 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a second embodiment of the second variant, said composition of the second variant comprises:
a) notably 35% to 75%, in particular 35% to 65%, in particular 35% to 55% by weight of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment of the second variant, said composition of the second variant comprises:
a) 35% to 90%, in particular 35% to 65%, in particular 35% to 55% by weight of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the second variant, said composition of the second variant comprises:
a) 35% to 65%, in particular 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the second variant, said composition of the second variant comprises:
a) 35% to 80%, in particular 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the second variant, said composition of the second variant comprises:
a) 35% to 65%, in particular 35% to 55% by weight of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the second variant, said composition of the second variant comprises:
a) 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a third variant, said composition comprises:
a) 35% to 100% by weight, notably 35% to 75%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid;
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the third variant, said composition of the third variant comprises:
a) 35% to 90%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a second embodiment of the third variant, said composition of the third variant comprises:
a) notably 35% to 75%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment of the third variant, said composition of the third variant comprises:
a) 35% to 90%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the third variant, said composition of the third variant comprises:
a) 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the third variant, said composition of the third variant comprises:
a) 35% to 80%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the third variant, said composition of the third variant comprises:
a) 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the third variant, said composition of the third variant comprises:
a) 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth variant, said composition consists of:
a) 35% to 100% by weight, notably 35% to 75%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid, said semicrystalline aliphatic polyamide and/or said polyamide of formula MXDZ having a total acidity between from 70 to 180 μeq/g and a total basicity of less than 100 μeq/g, in particular less than 35 μeq/g;
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the fourth variant, said composition of the third variant consists of:
a) 35% to 90%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a second embodiment of the fourth variant, said composition consists of:
a) notably 35% to 75%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment of the fourth variant, said composition consists of:
a) 35% to 90%, in particular 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the fourth variant, said composition consists of:
a) 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) from 10% to 25% by weight of polyolefins;
c) from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the fourth variant, said composition consists of:
a) 35% to 80%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the fourth variant, said composition consists of:
a) 35% to 65%, in particular 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the fourth variant, said composition consists of:
a) 35% to 55% by weight of at least one semicrystalline aliphatic polyamide and/or one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fifth variant, said composition consists of:
a) 35% to 100% by weight, notably 35% to 75%, in particular 35% to 65%, in particular 35% to 55% by weight of at least one semicrystalline aliphatic polyamide,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the fifth variant, said composition of the first variant consists of:
a) 35% to 90% by weight, in particular 35% to 65%, in particular 35% to 55% by weight of at least one semicrystalline aliphatic polyamide,
b) 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a second embodiment of the fifth variant, said composition of the first variant consists of:
a) notably 35% to 75% by weight, in particular 35% to 65%, in particular 35% to 55% by weight of at least one semicrystalline aliphatic polyamide,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment of the fifth variant, said composition of the first variant consists of:
a) 35% to 90% by weight, in particular 35% to 65%, in particular 35% to 55% by weight of at least one semicrystalline aliphatic polyamide,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the fifth variant, said composition of the first variant consists of:
a) 35% to 65%, in particular 35% to 55% by weight of at least one semicrystalline aliphatic polyamide,
b) 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the fifth variant, said composition of the first variant consists of:
a) 35% to 80%, in particular 35% to 55% by weight of at least one semicrystalline aliphatic polyamide,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the fifth variant, said composition of the first variant consists of:
a) 35% to 65%, in particular 35% to 55% by weight of at least one semicrystalline aliphatic polyamide,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the fifth variant, said composition of the first variant consists of:
a) 35% to 55% by weight of at least one semicrystalline aliphatic polyamide,
b) 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth variant, said composition consists of:
a) 35% to 100% by weight, notably 35% to 75%, in particular 35% to 65%, in particular 35% to 55% by weight of at least one polyamide of formula MXDZ wherein MXD is meta-xylylenediamine and Z is a C6 to C12 aliphatic dicarboxylic acid;
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the sixth variant, said composition of the second variant consists of:
a) 35% to 90%, in particular 35% to 65%, in particular 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight; the sum a)+b)+c)+d)+e) being equal to 100%.

In a second embodiment of the sixth variant, said composition of the second variant consists of:
a) notably 35% to 75%, in particular 35% to 65%, in particular 35% to 55% by weight of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight; the sum a)+b)+c)+d)+e) being equal to 100%.

In a third embodiment of the sixth variant, said composition of the second variant consists of:
a) 35% to 90%, in particular 35% to 65%, in particular 35% to 55% by weight of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the sixth variant, said composition of the second variant consists of:
a) 35% to 65%, in particular 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the sixth variant, said composition of the second variant consists of:
a) 35% to 80%, in particular 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the sixth variant, said composition of the second variant consists of:
a) 35% to 65%, in particular 35% to 55% by weight of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the sixth variant, said composition of the second variant consists of:
a) 35% to 55% by weight of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh variant, said composition consists of:
a) 35% to 100% by weight, notably 35% to 75%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid;
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a first embodiment of the seventh variant, said composition of the third variant consists of:
a) 35% to 90%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 0 to 30% by weight of at least one flame retardant, notably from 10% to 30% by weight; the sum a)+b)+c)+d)+e) being equal to 100%.

In a second embodiment of the seventh variant, said composition of the third variant consists of:
a) notably 35% to 75%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a third embodiment of the seventh variant, said composition of the third variant consists of:
a) 35% to 90%, in particular 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a fourth embodiment of the seventh variant, said composition of the third variant consists of:
a) 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 0 to 30% by weight of at least one flame retardant, notably from 10% to 30% by weight;
the sum a)+b)+c)+d)+e) being equal to 100%.

In a fifth embodiment of the seventh variant, said composition of the third variant consists of:
a) 35% to 80%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 0 to 60% by weight, in particular from 25% to 60% by weight of glass fibers;
d) 0 to 2% by weight of at least one additive;
e) 10% to 30% by weight of at least one flame retardant;
the sum a)+b)+c)+d)+e) being equal to 100%.

In a sixth embodiment of the seventh variant, said composition of the third variant consists of:
a) 35% to 65%, in particular 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 0 to 25% by weight, in particular from 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a seventh embodiment of the seventh variant, said composition of the third variant consists of:
a) 35% to 55% by weight of at least one semicrystalline aliphatic polyamide and of at least one polyamide of formula MXDZ wherein MXD is meta-xylylenediamine and Z is a C6 to C12 aliphatic dicarboxylic acid,
b) 10% to 25% by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

In a first particular embodiment, the composition used in the case where said metal part is made of aluminum and said aluminum part is physically or chemically pretreated, consists of:
a) 35% to 100% by weight, notably 35% to 75%, in particular from 35% to 65% of said at least one semicrystalline aliphatic polyamide and/or one polyamide of formula MXDZ;
c) 0 to 60%, in particular from 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

In a first variant of this first particular embodiment, said composition consists of:
a) 35% to 100% by weight, notably 35% to 75%, in particular from 35% to 65% of said at least one semicrystalline aliphatic polyamide;
c) 0 to 60%, in particular from 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

Advantageously, said composition consists of:
a) 35% to 75%, in particular 35% to 65% of said of at least one semicrystalline aliphatic polyamide;
c) 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

Advantageously, said composition consists of:
a) 35% to 90% by weight, in particular from 35% to 65% of said of at least one semicrystalline aliphatic polyamide;
c) 0 to 60%, in particular from 25% to 60% by weight of glass fibers;
d) 0 to 2% by weight of at least one additive;
e) 10% to 30% by weight of at least one flame retardant;
the sum a)+c)+d)+e) being equal to 100%.

Advantageously, said composition consists of:
a) 35% to 65% of said at least one semicrystalline aliphatic polyamide;
c) 25% to 60% by weight of glass fibers;
d) 0 to 2% by weight of at least one additive;
e) 10% to 30% by weight of at least one flame retardant;
the sum a)+c)+d)+e) being equal to 100%.

In a second variant of this first particular embodiment, said composition consists of:
a) 35% to 100% by weight, notably 35% to 75%, in particular from 35% to 65% of said at least one polyamide of formula MXDZ;
c) 0 to 60%, in particular from 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

Advantageously, said composition consists of:
a) 35% to 75%, in particular from 35% to 65% of said of at least one polyamide of formula MXDZ;
c) 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

Advantageously, said composition consists of:
a) 35% to 90% by weight, in particular from 35% to 65% of said of at least one polyamide of formula MXDZ;
c) 0 to 60%, in particular from 25% to 60% by weight of glass fibers;
d) 0 to 2% by weight of at least one additive;
e) 10% to 30% by weight of at least one flame retardant;
the sum a)+c)+d)+e) being equal to 100%.

Advantageously, said composition consists of:
a) 35% to 65% of said at least one polyamide of formula MXDZ;
c) 25% to 60% by weight of glass fibers;
d) 0 to 2% by weight of at least one additive;
e) 10% to 30% by weight of at least one flame retardant;
the sum a)+c)+d)+e) being equal to 100%.

In a third variant of this first particular embodiment, said composition consists of:
a) 35% to 100% by weight, notably 35% to 75%, in particular from 35% to 65% of said at least one semicrystalline aliphatic polyamide and of said at least one polyamide of formula MXDZ;
c) 0 to 60%, in particular from 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

Advantageously, said composition consists of:
a) 35% to 75%, in particular from 35% to 65% of said at least one semicrystalline aliphatic polyamide and of said at least one polyamide of formula MXDZ;
c) 25% to 60% by weight of glass fibers;
d) 0 to 2% by weight of at least one additive;
e) 0 to 30% by weight of at least one flame retardant, in particular 10% to 30% by weight of at least one flame retardant;
the sum a)+c)+d)+e) being equal to 100%.

Advantageously, said composition consists of:
a) 35% to 90% by weight, in particular from 35% to 65% of said at least one semicrystalline aliphatic polyamide and of said at least one polyamide of formula MXDZ;
c) 0 to 60%, in particular from 25% to 60% by weight of glass fibers;
d) 0 to 2% by weight of at least one additive;
e) 10% to 30% by weight of at least one flame retardant;
the sum a)+c)+d)+e) being equal to 100%.

Advantageously, said composition consists of:
a) 35% to 65% of said at least one semicrystalline aliphatic polyamide and of said at least one polyamide of formula MXDZ;
c) 25% to 60% by weight of glass fibers;
d) 0 to 2% by weight of at least one additive;
e) 10% to 30% by weight of at least one flame retardant;
the sum a)+c)+d)+e) being equal to 100%.

The adhesion of said composition of this first particular embodiment and of said variants to said metal part is greater than 10 MPa, in particular greater than 15 MPa, notably greater than 20 MPa as measured according to standard ISO 19095-2015.

In a second particular embodiment, the composition used in the case where said metal part is made of stainless steel and said stainless steel part is physically or chemically pretreated, consists of:
a) 35% to 75%, in particular 35% to 65%, in particular 35% to 55% by weight of said at least one semicrystalline aliphatic polyamide and/or one polyamide of formula MXDZ;
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight; the sum a)+b)+c)+d)+e) being equal to 100%.

In a first variant of this second particular embodiment, said composition consists of:
a) 35% to 75% by weight, in particular 35% to 65%, in particular 35% to 55% by weight of said at least one semicrystalline aliphatic polyamide,
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight;
the sum a)+b)+c)+d)+e) being equal to 100%.

Advantageously, said composition consists of:
a) 35% to 65%, in particular 35% to 55% by weight of said at least one semicrystalline aliphatic polyamide;
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 10% to 30% by weight of at least one flame retardant;
the sum a)+b)+c)+d)+e) being equal to 100%.

Advantageously, said composition consists of:
a) 35% to 65% by weight of said at least one semicrystalline aliphatic polyamide;
b) 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight;
the sum a)+b)+c)+d)+e) being equal to 100%.

Advantageously, said composition consists of:
a) 35% to 55% by weight of said at least one semicrystalline aliphatic polyamide;
b) 10% to 25% by weight of polyolefins;
c) 25% to 60% by weight of glass fibers, notably of circular cross section;
d) 0 to 2% by weight of at least one additive;
e) 10% to 30% by weight of at least one flame retardant;
the sum a)+b)+c)+d)+e) being equal to 100%.

In a second variant of this second particular embodiment, said composition consists of:
a) 35% to 75%, in particular 35% to 65%, in particular 35% to 55% by weight of said at least one polyamide of formula MXDZ;
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight;
the sum a)+b)+c)+d)+e) being equal to 100%.

Advantageously, said composition consists of:
a) 35% to 65%, in particular 35% to 55% by weight of said at least one polyamide of formula MXDZ;
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 10% to 30% by weight of at least one flame retardant;
the sum a)+b)+c)+d)+e) being equal to 100%.

Advantageously, said composition consists of:
a) 35% to 65%, in particular 35% to 55% by weight of said at least one polyamide of formula MXDZ;
b) 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight;
the sum a)+b)+c)+d)+e) being equal to 100%.

Advantageously, said composition consists of:
a) 35% to 55% by weight of said at least one polyamide of formula MXDZ;
b) 10% to 25% by weight of polyolefins;
c) 25% to 60% by weight of glass fibers, notably of circular cross section;
d) 0 to 2% by weight of at least one additive;
e) 10% to 30% by weight of at least one flame retardant;
the sum a)+b)+c)+d)+e) being equal to 100%.

In a third variant of this second particular embodiment, said composition consists of:
a) 35% to 75%, in particular 35% to 65%, in particular 35% to 55% by weight of said at least one semicrystalline aliphatic polyamide and of said one polyamide of formula MXDZ;
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight;
the sum a)+b)+c)+d)+e) being equal to 100%.

Advantageously, said composition consists of:
a) 35% to 65%, in particular 35% to 55% by weight of said at least one semicrystalline aliphatic polyamide and of said at least one polyamide of formula MXDZ;
b) 0 to 25% of polyolefins, in particular from 10% to 25% by weight of polyolefins;
c) 25% to 60% by weight of glass fibers, notably of circular cross section;
d) 0 to 2% by weight of at least one additive;
e) 10% to 30% by weight of at least one flame retardant;
the sum a)+b)+c)+d)+e) being equal to 100%.

Advantageously, said composition consists of:
a) 35% to 65%, in particular 35% to 55% by weight of said at least one semicrystalline aliphatic polyamide and of said at least one polyamide of formula MXDZ;
b) 10% to 25% by weight of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight;
the sum a)+b)+c)+d)+e) being equal to 100%.

Advantageously, said composition consists of:
a) 35% to 55% by weight of said at least one semicrystalline aliphatic polyamide and of said at least one polyamide of formula MXDZ;
b) 10% to 25% by weight of polyolefins;
c) 25% to 60% by weight of glass fibers, notably of circular cross section;
d) 0 to 2% by weight of at least one additive;
e) 10% to 30% by weight of at least one flame retardant;
the sum a)+b)+c)+d)+e) being equal to 100%.

In a third particular embodiment, the composition used in the case where said metal part is made of stainless steel and said stainless steel part is physically or chemically pretreated, consists of:
a) 35% to 65% by weight of said at least one semicrystalline aliphatic polyamide and/or one polyamide of formula MXDZ;
b) 10% to 25% by weight of polyolefins;
c) 25% to 60% by weight of glass fibers, notably of circular cross section;
d) 0 to 2% by weight of at least one additive;
the sum a)+b)+c)+d) being equal to 100%.

In a first variant of this third particular embodiment, said composition consists of:
a) 35% to 65% by weight of said at least one semicrystalline aliphatic polyamide;
b) 10% to 25% by weight of polyolefins;
c) 25% to 60% by weight of glass fibers, notably of circular cross section;
d) 0 to 2% by weight of at least one additive;
the sum a)+b)+c)+d) being equal to 100%.

In a second variant of this third particular embodiment, said composition consists of:
a) 35% to 65% by weight of said at least one polyamide of formula MXDZ;
b) 10% to 25% by weight of polyolefins;
c) 25% to 60% by weight of glass fibers, notably of circular cross section;
d) 0 to 2% by weight of at least one additive;
the sum a)+b)+c)+d) being equal to 100%.

In a third variant of this second particular embodiment, said composition consists of:
a) 35% to 65% by weight of said at least one semicrystalline aliphatic polyamide and of formula MXDZ;
b) 10% to 25% by weight of polyolefins;
c) 25% to 60% by weight of glass fibers, notably of circular cross section;
d) 0 to 2% by weight of at least one additive;
the sum a)+b)+c)+d) being equal to 100%.

Advantageously, throughout the description, when the semicrystalline aliphatic polyamide is mixed with a polyamide of formula MXDZ, then the MXDZ is in proportions by weight of 25% to 45% relative to the sum of the semicrystalline aliphatic polyamides and the polyamides of formula MXDZ.

The adhesion of said composition of these second and third particular embodiments and of said variants to said metal part is greater than 10 MPa, in particular greater than 15 MPa, notably greater than 20 MPa as measured according to standard ISO 19095-2015.

Advantageously, said composition of these second and third particular embodiments has a dielectric constant, Dk, of less than or equal to 5.0, notably less than or equal to 4.5, notably less than or equal to 4, in particular less than or equal to 3.5 as measured according to ASTM D-2520-13, at a frequency of at least 1 GHz, notably at a frequency of at least 2 GHz, in particular at a frequency of at least 3 GHz, at 23° C., under 50% RH.

Advantageously, said composition of these second and third particular embodiments has a Df<0.015 at a frequency of at least 1 GHz, notably at a frequency of at least 2 GHz, in particular at a frequency of at least 3 GHz, at 23° C., under 50% RH, measured according to ASTM D-2520-13.

Regarding the Polyamides:
The polyamides of said composition are chosen from semicrystalline aliphatic polyamides, polyamides of formula MXDZ and mixtures thereof.

When they are mixed, each semicrystalline aliphatic polyamide and each polyamide of formula MXDZ has particular total acidity and total basicity ranges.

Regarding the Semicrystalline Aliphatic Polyamide:

For the purposes of the invention, a semicrystalline polyamide denotes a polyamide which has a glass transition temperature in DSC according to the standard ISO 11357-2: 2013 and also a melting point (Tm) in DSC according to the standard ISO 11357-3: 2013, and an enthalpy of crystallization during the cooling step at a rate of 20 K/min in DSC measured according to the standard ISO 11357-3 of 2013 of greater than 30 J/g, preferably greater than 40 J/g.

The nomenclature used to define the polyamides is described in the standard ISO 1874-1:2011 “Plastics—Polyamide (PA) moulding and extrusion materials—Part 1: Designation”, notably on page 3 (tables 1 and 2), and is well known to those skilled in the art.

The expression “aliphatic polyamide” means a homopolyamide or a copolyamide. It is clearly understood that it may be a mixture of aliphatic polyamides.

The mean number of carbon atoms relative to the nitrogen atom is greater than or equal to 6.

Advantageously, it is greater than or equal to 8.

In the case of a PA-X·Y type homopolyamide, the number of carbon atoms per nitrogen atom is the mean of the X unit and the Y unit.

In the case of a copolyamide, the number of carbons per nitrogen is calculated according to the same principle. The calculation is made on a molar pro rata basis of the various amide units.

In a First Embodiment:

In a first variant of this first embodiment, the semicrystalline aliphatic polyamide is obtained from the polycondensation of at least one aminocarboxylic acid comprising from 6 to 18 carbon atoms, preferentially from 8 to 12 carbon atoms, more preferentially from 10 to 12 carbon atoms. It can thus be chosen from 6-aminohexanoic acid, 7-aminoheptanoic acid, 8-aminooctanoic acid, 9-aminononanoic acid, 10-aminodecanoic acid, 11-aminoundecanoic acid and 12-aminododecanoic acid, 13-aminotridecanoic acid, 14-aminotetradecanoic acid, 15-aminooctadecanoic acid, 16-aminohexadecanoic acid, 17-aminoheptadecanoic acid, 18-aminooctadecanoic acid.

Preferentially, it is obtained from the polycondensation of a single aminocarboxylic acid.

In a second variant of this first embodiment, the semicrystalline aliphatic polyamide is obtained from the polycondensation of at least one lactam comprising from 6 to 18 carbon atoms, preferentially from 8 to 12 carbon atoms, more preferentially from 10 to 12 carbon atoms.

Preferentially, it is obtained from the polycondensation of a single lactam.

In a third variant of this first embodiment, the semicrystalline aliphatic polyamide is obtained from the polycondensation of at least one aliphatic diamine comprising from 4 to 36 carbon atoms, advantageously from 6 to 18 carbon atoms, advantageously from 6 to 12 carbon atoms, advantageously from 10 to 12 carbon atoms and from at least one aliphatic dicarboxylic acid comprising from 4 to 36 carbon atoms, advantageously from 6 to 18 carbon atoms, advantageously from 6 to 12 carbon atoms, advantageously from 8 to 12 carbon atoms.

The aliphatic diamine used to obtain this repeating unit X. Y is an aliphatic diamine which has a linear main chain comprising at least 4 carbon atoms.

This linear main chain can, where appropriate, comprise one or more methyl and/or ethyl substituents; in said configuration, the term “branched aliphatic diamine” is used. In the case where the main chain comprises no substituent, the aliphatic diamine is termed “linear aliphatic diamine”.

Whether or not it comprises methyl and/or ethyl substituents on the main chain, the aliphatic diamine used to obtain this repeating unit X·Y comprises from 4 to 36 carbon atoms, advantageously from 4 to 18 carbon atoms, advantageously from 6 to 18 carbon atoms, advantageously from 6 to 14 carbon atoms.

When this diamine is a linear aliphatic diamine, it then corresponds to the formula H₂N—(CH₂)ₓ—NH₂ and can be chosen for example from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines that have just been mentioned may all be biobased within the meaning of standard ASTM D6866.

When this diamine is a branched aliphatic diamine, it can in particular be 2-methylpentanediamine, 2-methyl-1,8-octanediamine or (2,2,4 or 2,4,4) trimethylenehexanediamine.

The dicarboxylic acid may be selected from linear or branched aliphatic dicarboxylic acids.

When the dicarboxylic acid is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and fatty acid dimers containing 36 carbons.

The fatty acid dimers mentioned above are dimerized fatty acids obtained by oligomerization or polymerization of unsaturated monobasic fatty acids with a long hydrocarbon chain (such as linoleic acid and oleic acid), as described in particular in document EP 0 471 566.

In a fourth variant of this first embodiment, the semicrystalline aliphatic polyamide is obtained from a mixture of these three variants.

In a Second Embodiment:

In a first variant of this second embodiment, the semicrystalline aliphatic polyamide is obtained from the polycondensation of at least one aminocarboxylic acid comprising from 6 to 18 carbon atoms, preferentially from 8 to 12 carbon atoms, more preferentially from 10 to 12 carbon atoms.

Preferentially, it is obtained from the polycondensation of a single aminocarboxylic acid.

In a second variant of this second embodiment, the semicrystalline aliphatic polyamide is obtained from the polycondensation of at least one lactam comprising from 6 to 18 carbon atoms, preferentially from 8 to 12 carbon atoms, more preferentially from 10 to 12 carbon atoms.

Preferentially, it is obtained from the polycondensation of a single lactam.

In a third embodiment, said semicrystalline polyamide is chosen from PA410, PA510, PA512, PA514, PA610, PA612, PA1010, PA1012, PA1212, PA11 and PA12, in particular PA1010, PA1012, PA1212, PA11, PA12.

Advantageously, said semicrystalline polyamide is chosen from PA11 and PA12, in particular PA11.

Advantageously, a single semicrystalline polyamide is present in the composition.

Regarding the Polyamide of Formula MXDZ

MXD corresponds to meta-xylylenediamine.

Z is an aliphatic and linear C6 to C12 dicarboxylic acid which can be selected from adipic acid (6), heptanedioic acid (7), octanedioic acid (8), azelaic acid (9), sebacic acid (10), undecanedioic acid (11), dodecanedioic acid (12).

Advantageously, MXDZ is chosen from MXD10 and MXD12, in particular MXD10.

Advantageously, a single MXDZ polyamide is present in the composition.

Advantageously, a mixture of a single semicrystalline polyamide and a single MXDZ polyamide is present in the composition.

Regarding the Polyolefin:

The polyolefin of said composition may be a grafted (or functionalized) polyolefin or non-grafted (or non-functionalized) polyolefin or a mixture thereof.

The grafted polyolefin may be a polymer of α-olefins having reactive units (the functionalities); such reactive units are acid, anhydride or epoxy functions. Mention may be made, by way of example, of the preceding non-grafted polyolefins but which are grafted or copolymerized or terpolymerized by unsaturated epoxides, such as glycidyl (meth)acrylate, or by carboxylic acids or the corresponding salts or esters, such as (meth)acrylic acid (it being possible for the latter to be completely or partially neutralized by metals such as Zn, etc.), or else by carboxylic acid anhydrides, such as maleic anhydride.

Advantageously, the grafted polyolefin is chosen from esters of unsaturated carboxylic acids, such as, for example, alkyl acrylates or alkyl methacrylates, said alkyls preferably having from 1 to 24 carbon atoms; examples of alkyl acrylate or methacrylate are notably methyl methacrylate, ethyl acrylate, n-butyl acrylate, isobutyl acrylate or 2-ethylhexyl acrylate;

vinyl esters of saturated carboxylic acids, such as, for example, vinyl acetate or vinyl propionate.

Advantageously, said grafted polyolefin defined above is based on polypropylene.

A non-grafted polyolefin is conventionally a homopolymer or copolymer of alpha-olefins or of diolefins, such as, for example, ethylene, propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, 1-docosene, 1-tetracosene, 1-hexacosene, 1-octacosene and 1-triacontene, preferably propylene or ethylene or diener such as for example butadiene, which can be mixed with a compatible and functional compatibilizer, for example a polyethylene mixed with a maleized Lotader® or with a maleized polyethylene, isoprene or 1,4-hexadiene.

In particular, the alpha-olefin homopolymer is chosen from low-density polyethylenes (LDPE), high-density polyethylenes (HDPE), linear low-density polyethylenes (LLDPE), very low density polyethylene (VLDPE) and metallocene polyethylene.

In particular, the copolymers of alpha-olefins or of diolefins are chosen from ethylene/alpha-olefin polymers such as ethylene-propylene, ethylene-butylene, ethylene-propylene-diene monomer, ethylene-octene, alone or in a mixture with a polyethylene (PE).

Advantageously, said non-grafted polyolefin defined above is based on polypropylene.

The polyolefin of the composition may also be crosslinked or non-crosslinked or be a mixture of at least one which is crosslinked and/or at least one which is non-crosslinked

With Regard to the Glass Fibers:

For the purposes of the invention, a glass fiber is understood to mean any glass fiber, in particular as described by Frederick T. Wallenberger, James C. Watson and Hong Li, PPG Industries Inc. (ASM Handbook, Vol 21: Composites (#06781G), 2001 ASM International)

They can be of any shape whatsoever, in particular a shape having a circular cross section or a shape having a non-circular cross section.

A shape having a circular cross section is defined as a shape having at any point of its circumference an equal distance to the center of the shape and therefore represents a perfect or near-perfect circle.

Any shape of glass that does not have this perfect or near-perfect circle is therefore defined as a shape having a non-circular cross section.

Examples of shapes having a non-circular cross section, without being limited thereto, are flat shapes, for example an elliptical, oval or cocoon shape, star shapes, flake shapes, cruciforms, a polygon and a ring.

Solid glass fibers may notably be solid and short glass fibers which, preferably, have a length of between 2 and 13 mm, preferably from 3 to 8 mm before use of the compositions.

The solid glass fiber may be:
either of circular cross section with a diameter between from 4 μm to 25 μm, preferably from 4 to 15 μm;
or of non-circular cross section with an LID ratio (L representing the largest dimension of the cross section of the fiber and D the smallest dimension of the cross section of said fiber) between from 2 to 8, in particular from 2 to 4. L and D can be measured by scanning electron microscopy (SEM).

The glass fibers can also be mixed with hollow glass fibers.

Hollow glass fibers may notably be hollow and short glass fibers which, preferably, have a length of between 2 and 13 mm, preferably from 3 to 8 mm before use of the compositions.

Hollow glass fibers should be understood to mean glass fibers for which the hollow (or hole or lumen) in the fiber is not necessarily concentric with the outer diameter of said fiber.

The hollow glass fiber may be:
either of circular cross section with an outer diameter between from 7.5 to 75 μm, preferentially from 9 to 25 μm, more preferentially from 10 to 12 μm.

It is obvious that the diameter of the hollow (the term “hollow” can also be referred to as either hole or lumen) is not equal to the outer diameter of the glass fiber.

Advantageously, the diameter of the hollow (or hole or lumen) represents from 10% to 80%, in particular from 60% to 80% of the outer diameter of the hollow fiber.
or of non-circular cross section with an LID ratio (L representing the largest dimension of the cross section of the fiber and D the smallest dimension of the cross section of said fiber) between from 2 to 8, in particular from 2 to 4. L and D can be measured by scanning electron microscopy (SEM).

Said mixture of solid and hollow glass fibers comprises from 5% to 50% by weight of hollow glass fibers (notably hollow glass beads) relative to the total of the solid and hollow glass fibers, in particular from 5% to 35% by weight of hollow glass beads relative to the total of the solid and hollow glass fibers.

In one embodiment, the glass fibers are solid glass fibers, excluding hollow glass fibers, notably hollow glass beads.

The hollow glass beads have a compressive strength, measured according to ASTM D 3102-72 (1982) in glycerol, of at least 50 MPa and particularly preferably of at least 100 MPa.

Advantageously, the hollow glass beads have a volume mean diameter d₅₀ from 10 to 80 μm, preferably from 13 to 50 μm, measured by means of laser diffraction in accordance with standard ASTM B 822-17.

The hollow glass beads can be surface treated with, for example, systems based on aminosilanes, epoxysilanes, polyamides, in particular water-soluble polyamides, fatty acids, waxes, silanes, titanates, urethanes, polyhydroxyethers, epoxides, nickel or mixtures thereof can be used for this purpose. The hollow glass beads are preferably surface treated with aminosilanes, epoxysilanes, polyamides or mixtures thereof.

The hollow glass beads can be formed from a borosilicate glass, preferably from sodium carbonate-calcium oxide-borosilicate glass.

The hollow glass beads preferably have a median diameter d₅₀ from 10 to 80 μm, preferentially from 13 to 50 μm, as measured by laser diffraction according to ASTM B 822-17.

The distribution is expressed here by volume.

The hollow glass beads preferably have a true density of from 0.10 to 0.65 g/cm³, preferably from 0.20 to 0.60 g/cm³, particularly preferably from 0.30 to 0.50 g/cm³, measured according to ASTM D 2840-69 (1976) with a gas pycnometer and helium as the measuring gas.

Advantageously, the hollow glass beads have a compressive strength, as measured according to ASTM D 3102-72 (1982) in glycerol, of at least 50 MPa, in particular of at least 100 MPa.

In one embodiment, the hollow glass beads are devoid of treatment with a silane-based coupling agent.

Regarding the Flame Retardants:

The flame retardant is notably a halogen-free flame retardant, as described in US 2008/0274355 and notably a phosphorus-based flame retardant, for example a metal salt chosen from a metal salt of phosphinic acid, in particular dialkyl phosphinate salts, notably diethylphosphinate aluminum salt or aluminum diethylphosphinate, a metal salt of diphosphinic acid, a mixture of an aluminum phosphinate flame retardant and a nitrogen synergist or a mixture of an aluminum phosphinate flame retardant and a phosphorus synergist, a polymer containing at least one metal salt of phosphinic acid, notably based on ammonium such as an ammonium polyphosphate, sulfamate or pentaborate, or based on melamine such as melamine, melamine salts, melamine pyrophosphates and melamine cyanurates, or based on cyanuric acid, or else a polymer containing at least one metal salt of diphosphinic acid or red phosphorus, an antimony oxide, a zinc oxide, an iron oxide, a magnesium oxide or metal borates such as a zinc borate, or phosphazenes, a phospham or a phospho-oxynitride or a mixture thereof. The flame retardant fillers may also be halogenated flame retardants such as a brominated or polybrominated polystyrene, a brominated polycarbonate or a brominated phenol.

According to another aspect, the present invention relates to a composition as defined above, comprising:
a) 35% to 75% by weight, in particular 35% to 65%, in particular 35% to 55%, in particular 35% to 50%, by weight of said at least one semicrystalline aliphatic polyamide and/or one polyamide of formula MXDZ having a total acidity between from 70 to 180 μeq/g and a total basicity of less than 100 μeq/g, in particular less than 35 μeq/g,
b) 0 to 25% by weight, preferentially from 10% to 25%, of polyolefins;
c) 25% to 60% by weight of glass fibers, notably of circular cross section;
d) 0 to 2% by weight of at least one additive;
e) 0 to 30% by weight of at least one flame retardant, notably from 10% to 30% by weight, in particular from 15% to 25% by weight;
the sum a)+b)+c)+d)+e) being equal to 100%,
said semicrystalline aliphatic polyamide and/or said polyamide of formula MXDZ having a melt flow index (MFI) between from 4 to 50 g/10 min, as measured according to standard ISO 1133:2011 under a load of 2.16 kg at 210° C.

In a first embodiment, said composition is characterized in that it consists of:
a) 35% to 75% by weight, in particular 35% to 65%, in particular 35% to 60%, by weight of at least one semicrystalline aliphatic polyamide and/or one polyamide of formula MXDZ having a total acidity between from 70 to 180 μeq/g and a total basicity of less than 100 μeq/g, in particular less than 35 μeq/g;
c) 25% to 60% by weight of glass fibers, notably of circular cross section;
d) 0 to 2% by weight of at least one additive;
e) 0 to 30% by weight of at least one flame retardant, notably from 10% to 30% by weight, in particular from 15% to 25% by weight;
the sum a)+c)+d)+e) being equal to 100%.

In a second embodiment, said composition is characterized in that it consists of:
a) 35% to 75% by weight, in particular 35% to 65% by weight of at least one semicrystalline aliphatic polyamide and/or one polyamide of formula MXDZ having a total acidity between from 70 to 180 μeq/g and a total basicity of less than 100 μeq/g, in particular less than 35 μeq/g;
b) 0 to 25% of polyolefins, in particular from 10% to 25% by weight of polyolefins;
c) 25% to 60% by weight of glass fibers, notably of circular cross section;
d) 0 to 2% by weight of at least one additive;
the sum a)+b)+c)+d) being equal to 100%.

In a third embodiment, said composition is characterized in that it consists of:
a) 35% to 65% by weight of at least one semicrystalline aliphatic polyamide and/or one polyamide of formula MXDZ having a total acidity between from 70 to 180 μeq/g and a total basicity of less than 100 μeq/g, in particular less than 35 μeq/g;
b) 10% to 25% polyolefins;
c) 25% to 60% by weight of glass fibers, notably of circular cross section;
d) 0 to 2% by weight of at least one additive;
the sum a)+b)+c)+d) being equal to 100%.

In a first variant of one of the four compositions defined above, the constituent a) is only at least one semicrystalline aliphatic polyamide.

In a second variant of one of the four compositions defined above, the constituent a) is only at least one polyamide of formula MXDZ.

In a third variant of one of the four compositions defined above, the constituent a) is at least one semicrystalline aliphatic polyamide and at least one at least one polyamide of formula MXDZ.

According to another aspect, the present invention relates to a process for preparing an article for electrical and electronic applications comprising a step of injection molding, on a metal part, of a composition as defined above, to obtain a metal part coated on one of its surfaces with said composition.

In one embodiment, said metal part is chosen from magnesium, aluminum, alloys thereof, alloys of stainless steel and other iron-based alloys.

In another embodiment, said metal part is chemically or physically pretreated before injection molding of said composition.

In one variant, said metal part is made of aluminum and said aluminum part is physically or chemically pretreated.

In another variant, said metal part is made of stainless steel and said stainless steel part being physically or chemically pretreated.

In one embodiment of either of the two variants, the process further comprises a subsequent step of annealing in order to obtain a metal part coated with said composition and annealed.

In another embodiment, the process further comprises, after the annealing, a subsequent step of anodization in order to obtain a metal part coated with said composition which is annealed and which comprises an electrically insulating layer after anodization and which is ready for coloring and/or a subsequent posttreatment.

In yet another embodiment, the process further comprises, after the annealing, a subsequent step of coating a layer of metal, an alloy or a composite material on both surfaces of said coated metal part, it being possible for said coating step to be in particular by physical vapor deposition (PVD), by chemical vapor deposition (CVD), or by non-conductive vacuum metallization (NCVM), in particular by physical vapor deposition (PVD) or by chemical vapor deposition (CVD),

to obtain a coated, annealed metal part having a layer of metal, an alloy or a composite material on both surfaces of said coated metal part.

According to another aspect, the present invention relates to an article comprising a metal part coated on one or more of its surfaces with a composition as defined above.

In one embodiment, said article further comprises an electrically insulating layer after anodization.

In another embodiment, said article further comprises a layer of metal, an alloy or a composite material.

Advantageously, said article further comprising a layer of metal, an alloy or a composite material, further comprises a layer of adhesive over said layer of metal, alloy or composite material.

### EXAMPLES

Preparation of the compositions of the invention and mechanical properties:

The PA11 in EX1, EX3, EX4 and EX5 of table 1 below (Total basicity: 18 μeq/g, Total acidity: 103 μeq/g and MFI=47 g/10 min) is a PA11 limited by adipic acid (C6 diacid) at a content of 0.67% by weight relative to the amount of 11-aminoundecanoic acid charged.

This polyamide is prepared according to the following process. The 11-aminoundecanoic acid, water and adipic acid are charged to a reactor, then placed under an inert atmosphere. The temperature of the reaction medium is then raised to 235° C., while maintaining stirring. The reaction medium is maintained at 235° C., under a pressure of 20 bar for 1 h 30 min. Then, the pressure is reduced to 12 bar, while maintaining the temperature at 235° C. The material is then transferred to a polymerizer, under nitrogen flushing at 235° C.

The temperature is maintained under nitrogen flushing for 1 h 30 min. The material is then extruded in the form of granules.

This process is used for all the polyamides exemplified by varying the nature of the chain limiter and the concentration thereof, except for MXD10 for which meta-xylylene diamine and sebacic acid are used instead of 11-aminoundecanoic acid.

The PA11 in CE1 of table 1 below (Total basicity: 55 μeq/g, Total acidity: 17 μeq/g and MFI=5 g/10 min) is a PA11 limited by decanediamine (C10 diamine) at a content of 0.47% by weight relative to the amount of 11-aminoundecanoic acid charged.

The PA11 in CE3 of table 1 below (Total basicity: 97 μeq/g, Total acidity: 16 μeq/g and MFI=18 g/10 min) is a PA11 limited by decanediamine (C10 diamine) at a content of 0.47% by weight relative to the amount of 11-aminoundecanoic acid charged.

The PA11 in EX2 of table 1 below (Total basicity: 22 μeq/g, Total acidity: 71 μeq/g and MFI=6 g/10 min) is a PA11 limited by adipic acid (C6 diacid) at a content of 0.27% by weight relative to the amount of 11-aminoundecanoic acid charged.

The PA11 in CE2 of table 1 below has a total basicity=50 μeq/g and a total acidity=45 μeq/g and MFI=10 g/10 min.

The MXD10 in EX3 and EX5 of table 1 below has a total basicity: 24 μeq/g and a total acidity: 114 μeq/g and MFI=18 g/10 min.

The PA11 in CE4 of table 1 (MFI=2 g/10 min, having a total basicity=21 μeq/g and a total acidity: 75 μeq/g is a PA11 limited with 0.3% H₃PO₄.

The compositions of Table 1 were prepared by melt blending the polymer granules with the polyolefins when they are present, the glass fibers when they are present, the hollow glass beads when they are present, the flame retardants when they are present and the additives when they are present. This blending was carried out by compounding on a co-rotating twin-screw extruder with a diameter of 26 mm with a flat temperature profile (T°) at 240° C. The screw speed is 250 rpm and the throughput is 20 kg/h.

The glass fibers or hollow glass beads, when they are present, are introduced via side feeding.

The polyamide(s), the polyolefins and the additives are added during the compounding process via the main hopper.

The flame retardants, when they are present, are introduced via side feeding or via the main hopper.

TABLE 1

| | EX 1 | CE1 | EX 2 | EX3 | CE2 | EX 4 | CE3 | EX5 | CE4 |
|---|---|---|---|---|---|---|---|---|---|
| PA11 | 59.4 | | | 41.6 | | 39.4 | | 24.5 | |
| MFI = 47 g/10 min | | | | | | | | | |
| Total basicity: 18 μeq/g | | | | | | | | | |
| Total acidity: 103 μeq/g | | | | | | | | | |
| PA11 | | | 59.4 | | | | | | |
| MFI = 6 g/10 min Total | | | | | | | | | |
| basicity: 22 μeq/g | | | | | | | | | |
| Total acidity: 71 μeq/g | | | | | | | | | |
| PA11 | | 59.4 | | | | | | | |
| MFI = 5 g/10 min | | | | | | | | | |
| Total basicity: 55 μeq/g | | | | | | | | | |
| Total acidity: 17 μeq/g | | | | | | | | | |
| PA11 | | | | | | | 64.7 | | |
| MFI = 18 g/10 min | | | | | | | | | |
| Total basicity: 97 μeq/g | | | | | | | | | |
| Total acidity: 16 μeq/g | | | | | | | | | |
| PA 11 | | | | | 64.4 | | | | |
| MFI = 10 g/10 min | | | | | | | | | |
| Total basicity: 50 μeq/g | | | | | | | | | |
| Total acidity: 45 μeq/g | | | | | | | | | |
| PA11 | | | | | | | | | 59.4 |
| MFI = 2 g/10 min | | | | | | | | | |
| Total basicity = 21 μeq/g | | | | | | | | | |
| Total acidity: 75 μeq/g | | | | | | | | | |
| MXD10 | | | | 17.8 | | | | 10.2 | |
| MFI = 18 g/10 min | | | | | | | | | |
| Total basicity: 24 μeq/g | | | | | | | | | |
| Total acidity: 114 μeq/g | | | | | | | | | |
| E-glass fibers | 40.0 | 40.0 | 40.0 | 40.0 | 35.0 | 40.0 | 35 | 30 | 40 |
| Glass beads | | | | | | | | 20 | |
| Exolit OP1312 | | | | | | 20.0 | | | |
| Polypropylene | | | | | | | | 15 | |
| additives | 0.6 | 0.6 | 0.6 | 0.6 | 0.6 | 0.6 | 0.3 | 0.3 | 0.6 |
| Adhesion MPa | 34 | 19 | 25 | 32 | 10 | 26 | 17 | 31 | 16 |
| (without annealing) | | | | | | | | | |
| ISO 19095:2015 | | | | | | | | | |
| (average of 5 values) | | | | | | | | | |
| Dk 23° C., DAM @ 2 GHz | 3.6 | 3.6 | 3.6 | 3.6 | 3.5 | 3.8 | 3.5 | 3.1 | 3.6 |
| Df 23° C., DAM @ 2 GHz | 0.01 | 0.01 | 0.01 | 0.01 | 0.01 | 0.013 | 0.01 | 0.008 | 0.01 |

E-glass fibers: solid E-type glass fibers of circular cross section (Nitto Boseki CSX3J451S)
Exolit OP1312: flame retardant supplied by Clariant
Glass beads: Hollowlite HK60-18000 hollow glass beads
Polypropylene: mixture of PP5060 from Total and Orevac CA100 from SK Chemical

The MFI is measured according to standard ISO 1133:2011 under a load of 2.16 kg at 210° C.

1. The use of a composition comprising from:
a) 35% to 100% by weight of at least one semicrystalline aliphatic polyamide and/or one polyamide of formula MXDZ wherein MXD is meta-xylylenediamine and Z is a C6 to C12 aliphatic dicarboxylic acid, said semicrystalline aliphatic polyamide and/or said polyamide of formula MXDZ having a total acidity between from 70 to 180 μeq/g and a total basicity of less than 100 μeq/g,
a semicrystalline polyamide denoting a polyamide which has a glass transition temperature in DSC according to standard ISO 11357-2:2013 and also a melting temperature (Tm) in DSC according to standard ISO 11357-3:2013, and a enthalpy of crystallization during the cooling step at a rate of 20K/min in DSC measured according to standard ISO 11357-3 of 2013 of greater than 30 J/g, and said semicrystalline polyamide having an average number of carbon atoms relative to the nitrogen atom of greater than or equal to 6;
b) 0 to 25% by weight of polyolefins;
c) 0 to 60% by weight of glass fibers;
d) 0 to 2% by weight of at least one additive;
e) 0 to 30% by weight of at least one flame retardant;
the sum a)+b)+c)+d)+e) being equal to 100%,
said semicrystalline aliphatic polyamide and/or said polyamide of formula MXDZ having a melt flow index (MFI) between from 4 to 50 g/10 min, as measured according to standard ISO 1133:2011 under a load of 2.16 kg at 210° C.,
to increase the adhesion of said composition to a metal part after the deposition thereof by injection molding on said metal part, relative to the adhesion obtained after injection molding on said part with a composition comprising a semicrystalline aliphatic polyamide and/or a polyamide of formula MXDZ having at least one of the three properties, chosen from the MFI, total acidity and total basicity, which is different.

2. The use as claimed in claim 1, wherein said metal part is chosen from magnesium, aluminum, alloys thereof, alloys of stainless steel and other iron-based alloys.

3. The use as claimed in claim 1, wherein said metal part is chemically or physically pretreated before injection molding of said composition.

4. The use as claimed in claim 3, wherein said metal part is made of aluminum, said aluminum part being physically or chemically pretreated.

5. The use as claimed in claim 4, wherein said composition consists of:
a) 35% to 100% by weight of said at least one semicrystalline aliphatic polyamide and/or one polyamide of formula MXDZ;
c) 0 to 60% by weight of glass fibers;
d) 0 to 2% by weight of at least one additive;
e) 0 to 30% by weight of at least one flame retardant;
the sum a)+c)+d)+e) being equal to 100%.

6. The use as claimed in claim 4, wherein the adhesion of said composition to said metal part is greater than 10 MPa, as measured according to standard ISO 19095-2015.

7. The use as claimed in claim 3, wherein said metal part is made of stainless steel, said stainless steel part being physically or chemically pretreated.

8. The use as claimed in claim 7, wherein said composition consists of:
a) 35% to 65% by weight of at least one semicrystalline aliphatic polyamide and/or one polyamide of formula MXDZ;
b) 0 to 25% of polyolefins by weight of polyolefins;
c) 25% to 60% by weight of glass fibers;
d) 0 to 2% by weight of at least one additive;
e) 10% to 30% by weight of at least one flame retardant;
the sum a)+b)+c)+d)+e) being equal to 100%.

9. The use as claimed in claim 7, wherein said composition consists of:
a) 35% to 65% by weight of at least one semicrystalline aliphatic polyamide and/or one polyamide of formula MXDZ;
b) 10% to 25% polyolefins;
c) 25% to 60% by weight of glass fibers;
d) 0 to 2% by weight of at least one additive;
the sum a)+b)+c)+d) being equal to 100%.

10. The use as claimed in claim 7, wherein the composition has a dielectric constant, Dk, of less than or equal to 4.0, as measured according to ASTM D-2520-13, at a frequency of at least 1 GHz, at 23° C., under 50% RH.

11. The use as claimed in claim 7, wherein the composition has a Df<0.015 at a frequency of at least 1 GHz, at 23° C., under 50% RH, measured according to ASTM D-2520-13.

12. A composition as defined in claim 1, comprising:
a) 35% to 75% by weight of said at least one semicrystalline aliphatic polyamide and/or one polyamide of formula MXDZ having a total acidity between from 70 to 180 μeq/g and a total basicity of less than 100 μeq/g,
b) 0 to 25% by weight of polyolefins;
c) 25% to 60% by weight of glass fibers;
d) 0 to 2% by weight of at least one additive;
e) 0 to 30% by weight of at least one flame retardant;
the sum a)+b)+c)+d)+e) being equal to 100%,
said semicrystalline aliphatic polyamide and/or said polyamide of formula MXDZ having a melt flow index (MFI) between from 4 to 50 g/10 min, as measured according to standard ISO 1133:2011 under a load of 2.16 kg at 210° C.

13. The composition as claimed in claim 12, wherein it consists of:
a) 35% to 75% by weight by weight of at least one semicrystalline aliphatic polyamide and/or one polyamide of formula MXDZ having a total acidity between from 70 to 180 μeq/g and a total basicity of less than 100 μeq/g,
c) 25% to 60% by weight of glass fibers;
d) 0 to 2% by weight of at least one additive;
e) 0 to 30% by weight of at least one flame retardant;
the sum a)+c)+d)+e) being equal to 100%.

14. The composition as claimed in claim 12, wherein it consists of:
a) 35% to 75% by weight of at least one semicrystalline aliphatic polyamide and/or one polyamide of formula MXDZ having a total acidity between from 70 to 180 μeq/g and a total basicity of less than 100 μeq/g;
b) 0 to 25% of polyolefins;
c) 25% to 60% by weight of glass fibers;
d) 0 to 2% by weight of at least one additive;
the sum a)+b)+c)+d) being equal to 100%.

15. The composition as claimed in claim 12, wherein it consists of:
a) 35% to 65% by weight of at least one semicrystalline aliphatic polyamide and/or one polyamide of formula MXDZ having a total acidity between from 70 to 180 μeq/g and a total basicity of less than 100 μeq/g;
b) 10% to 25% polyolefins;
c) 25% to 60% by weight of glass fibers;
d) 0 to 2% by weight of at least one additive;
the sum a)+b)+c)+d) being equal to 100%.

16. A process for preparing an article for electrical and electronic applications comprising a step of injection molding, on a metal part, of a composition as defined in claim 1, to obtain a metal part coated on one of its surfaces with said composition.

17. The process as claimed in claim 16, wherein said metal part is chosen from magnesium, aluminum, alloys thereof, alloys of stainless steel and other iron-based alloys.

18. The process as claimed in claim 17, wherein said metal part is chemically or physically pretreated before injection molding of said composition.

19. The process as claimed in claim 18, wherein said metal part is made of aluminum, said aluminum part being physically or chemically pretreated.

20. The process as claimed in claim 18, wherein said metal part is made of stainless steel, said stainless steel part being physically or chemically pretreated.

21. The process as claimed in claim 19, wherein it further comprises a subsequent step of annealing in order to obtain a coated and annealed metal part.

22. The process as claimed in claim 21, wherein it further comprises, after the annealing, a subsequent step of anodization in order to obtain a coated, annealed metal part comprising an electrically insulating layer after anodization.

23. The process as claimed in claim 21, wherein it further comprises, after the annealing, a subsequent step of coating a layer of metal, an alloy or a composite material on both surfaces of said coated metal part,
to obtain a coated, annealed metal part having a layer of metal, an alloy or a composite material on both surfaces of said coated metal part.

24. An article comprising a metal part coated on one of its surfaces with a composition as defined in claim 1.

25. The article as claimed in claim 24, further comprising an electrically insulating layer after anodization.

26. The article as claimed in claim 25, further comprising a layer of metal, an alloy or a composite material.

27. The article as claimed in claim 26, further comprising a layer of adhesive over said layer of metal, alloy or composite material.
